(19) United States
(12) Patent Application Publication
(10) Pub. No.: US 2012/0299503 A1
(43) Pub. Date: Nov. 29, 2012

(54) RESONANT FLY-BACK POWER CONVERTER AND LED LIGHTING UNIT POWERED THEREFROM

(75) Inventor: Ilan Aharon, Aley Zahav (IL)

(73) Assignee: NahorLED Ltd., Aley Zahav (IL)

(21) Appl. No.: 13/574,623

(22) PCT Filed: Jan. 26, 2011
(86) PCT No.: PCT/IL11/00090

§ 371 Date: Jul. 23, 2012

Related U.S. Application Data
(60) Provisional application No. 61/298,227, filed on Jan. 26, 2010.

(51) Int. Cl. H02M 3/335; H05B 37/02

(52) U.S. Cl. 315/224; 363/21.12

(57) ABSTRACT

A method for controlling powering with a resonant fly-back power converter includes powering an output circuit including a load, with a inductor of a resonant fly-back power converter including a primary winding electrically connected to an input circuit of the fly-back converter and secondary winding electrically connected to the output circuit of the fly-back converter, operating the converter in a discontinuous conduction mode. Charging and discharging of the primary winding is controlled with a first and second switching element and a capacitor connected across the second switching element selected for resonating with the primary winding. Both first and second switching elements are operative to connect primary winding to an input voltage source over a defined on-time. The pulsing of the first and second switching elements is synchronized and the on-time of the second switching element is extended with respect to the on-time of the first switching element.

### FIELD OF THE INVENTION

The present invention relates to power converter and LED lighting units, and more particularly to power converters for LED lighting units.

### BACKGROUND OF THE INVENTION

Switching Mode Power Supplies (SMPS) are electronic power supplies that include electronic switches which commutate on and off at high frequency to connect and disconnect an energy storage inductor(s) and capacitor(s) to and from an input source or an output. By varying duty cycle, frequency or phase shift of the commutations, an output parameter, such as output voltage or current is controlled. SMPS are typically used to transfer power from an electrical power grid to an electronic device such as a personal computer. SMPS are also known to be used for powering LED lighting modules. SMPS may be used as AC-DC rectifiers, DC-DC voltage converters, DC-AC inverters, and/or AC-AC frequency changers.

LED lighting modules are becoming more common in many applications for replacing less efficient incandescent lamps. Depending on the amount of light required in the application, the LED lighting modules may consist of a plurality LED's arranged in a parallel or series configuration, or a combination of both. Optionally, the plurality of LED's are arranged in other patterns, for example in a hexagonal close packed pattern. Typically a panel of LED's are connected to a power source with a connecting device mounted or electrically connected to the panel of the LED.

Typically, LED lighting modules receive operating power from a low power DC-DC converter that switch direct current voltage ON and OFF at a high frequency. Such an SMPS may operate off AC house current but output voltage of the converter is typically isolated from the input main supply, e.g. the AC house current. Quasi-resonant fly-back and LLC resonant converters are exemplary DC-DC converters that operate off AC house current. Each of these converters is capable of supplying a modulated current to the LED lighting module in the form of a high frequency pulse width modulated signal.

One of the drawbacks to high frequency switching is dynamic power losses associated with a switching behavior of the switches of the converter, e.g. MOSFETs. Dynamic power losses reduce the efficiency of the converter. Switching frequencies that can be implemented as well as the compactness of the DC-DC converter may be limited due to losses in efficiency. One known method for reducing switching losses in resonant converters is zero-voltage switching. Ideally, if the pass devices always switch at zero voltage no switching losses will occur. In LLC resonant converters, zero-voltage switching is attempted by forcing the current flowing through the switch to reverse and clamping the voltage at a low value during switching. In quasi-resonant converter, a detection circuit is typically used to help determine the timing of a voltage minimum during a resonant state of the circuit.

U.S. Patent Application No. 20080278974 entitled “Quasi-Resonant Fly-Back Converter without Auxiliary Winding” the contents of which is incorporated herein by reference, describes a switching converter, which can detect the demagnetization of the transformer of the switching converter without utilizing an auxiliary winding and a complicated detection circuit. The switching converter includes a transformer, a switching transistor, a coupling circuit and a regulating circuit. The regulating circuit is coupled to the switching transistor and the coupling circuit and generates a control signal for the switching transistor based on coupling detected on the coupling circuit. The regulating circuit 320 comprises a zero-crossing detecting circuit 326 to detect zero-crossing of the coupled signal, a blanking circuit 324 and a PWM signal generator 322. The function of the blanking circuit 324 is for blanking the detecting result of the zero-cross detecting circuit 326 during a blanking time period corresponding to a switching frequency of the switching converter.

U.S. Pat. No. 5,850,126 entitled “Screw in LED Lamp” the contents of which is incorporated herein by reference, describes a screw in LED lamp that derives its power from a socket connected to an AC power line. The lamp includes a screw-in plug connected to a regulator in which the A-C is converted to a D-C voltage which is applied to a bank of LEDs through a power transistor. The power transistor is activated by a pulse generator yielding periodic pulses having a repetition rate of about 20 pulses per second. Each pulse activating the LEDs has duration of a few microseconds and a voltage magnitude producing a high current flow in each LED whose amplitude is a multiple of the normal current rating of the LED. As a consequence, the intensity of the light flashes is much higher than the normal light intensity, but because of the short duration of the pulses, the high current flow is not damaging to the LED.

### SUMMARY OF THE INVENTION

According to an aspect of some embodiments of the present invention, there is provided a resonant fly-back converter with reduced power losses due to switching. According to some embodiments of the present invention, the fly-back converter is operative to synchronize switching with a first valley of a resonant oscillating voltage and thereby obtain zero voltage switching. According to some embodiments of the present invention, the resonant fly-back converter is used for driving LED light modules.

According to another aspect of some embodiments of the present invention, there is provided a socket connector constructed from a PCB panel on which a power regulator for AC power line is mounted. According to some embodiments of the present invention, the PCB panel is formed with indentations along a thickness of the PCB panel that match threads in a screw socket so that the PCB can be screw directly into the socket. According to other embodiments of the present invention the PCB formed with protrusions that match pin holes on a pin socket so that the PCB can be directly inserted into the socket. According to some embodiments of the present invention, the indentations and/or protrusions are coated with a conductive material.

According to some embodiments of the present invention, the socket connector is additionally formed with one or more protrusions along an edge distal from a connection point with the socket, that are operative to engage, both mechanically and electrically, one or more slots formed on PCB panels on which the LEDs are mounted.

An aspect of some embodiments of the present invention is the provision of a method for controlling powering with a resonant fly-back power converter, the method comprising powering an output circuit including a load with a inductor of a resonant fly-back power converter including a primary winding electrically connected to an input circuit of the fly-back converter and secondary winding electrically connected to the output circuit of the fly-back converter, controlling charging and discharging of the primary winding with a first and second switching element, both first and second switching elements are operative to connect primary winding to an input voltage source over a defined on-time, wherein the pulsing of the first and second switching elements are synchronized and the on-time of the second switching element is extended with respect to the on-time of the first switching element.

Optionally, the on-time of the first switching element defines a charge level of the primary winding.

Optionally, the on-time of the second switching element defines a delay in an onset of a resonance period of the input circuit.

Optionally, the extended on-time is defined to synchronize the pulsing with a first valley of resonance voltage of the input circuit.

Optionally, the extended on-time is defined to synchronize pulsing with demagnetizing of the inductor.

Optionally, the method comprises directing current flow through a forward biased diode connected to the second switching element and the primary winding in response to release of the first switching element at the end of its on-time.

Optionally, the method comprises clamping current on the primary winding over the extended on-time of the second switching element.

Optionally, the method comprises discharging current on the primary winding to the output circuit after release of the second switching element.

Optionally, the input voltage source is a DC source.

Optionally, the converter operates at a constant switching frequency and wherein the on-time of the first switching element controls voltage output of the converter.

Optionally, the converter operates at a variable switching frequency and wherein on-time of the first switching element is constant over each commutation cycle.

Optionally, the load includes at least one LED lighting module.

An aspect of some embodiments of the present invention is the provision of a resonant fly-back power converter comprising an input DC voltage source, an input circuit including first and second switching elements, and a primary winding connected to the input voltage source via the first and second switching elements, each connected between a terminal of the primary winding and a terminal of the input voltage source, the winding being operative to supply power to an output circuit of the resonant fly-back power converter, wherein the first switching element is pulsed at a defined switching frequency and has an on-time operative to provide a defined charge level on the primary winding; wherein the second switching element is pulsed at the same switching frequency and in synchronization with the first switching element; and wherein an on-time of the second switching element is extended with respect to the on-time of the first switching element.

Optionally, the converter comprises at least one controller operative to control duration of on-times for each of the first and second switching elements.

Optionally, the converter enters a resonant period at an end of a commutation cycle of the pulsing and wherein the extended on-time is operative to delay the onset of the resonance period of the input circuit.

Optionally, the extended on-time is defined to synchronize the pulsing with a first valley of resonance of the resonance period.

Optionally, release of any one of the first and second switching element is operative to disconnect the input voltage source from the primary winding.

Optionally, release of the first switching element while maintaining the second switching element closed is operative to direct current flow through a forward biased diode connected to the second switching element and the primary winding.

Optionally, the forward biased diode is operative to clamp current on the primary winding.

Optionally, termination of the extended on-time of the second switching element prompts discharge of current on the primary winding to the output circuit.

Optionally, the converter comprises a resonance capacitor parallel to the second switching element, wherein the resonance capacitor is charged at a termination of the extended on-time and just prior to discharge of current on the primary winding to the output circuit.

Optionally, the input voltage source is a DC source.

Optionally, the converter operates at a constant switching frequency and wherein the on-time of the first switching element controls voltage output of the converter.

Optionally, the converter operates at a variable switching frequency, wherein on-time of the first switching element is constant over each commutation cycle and wherein the switching frequency controls voltage output of the converter.

Optionally, the load of the output circuit includes one or more LED lighting modules.

An aspect of some embodiments of the present invention is the provision of an LED lighting unit comprising a first printed circuit board formed with a pre-defined shape for attachment to a socket, and at least one second printed circuit board including at least one LED lighting module, and an attachment mechanism for physically and electrically connecting the first and second printed circuit board.

Optionally, the pre-defined shape is adapted to be screwed into a screw socket.

Optionally, the pre-defined shape is a pin head adapted to be clasped by a pin socket.

Optionally, the attachment mechanism includes one or more legs shaped from the first printed circuit board and matching slots cut out from the second printed circuit board.

Optionally, at least one slot includes bendable protrusion that bends in response to reception of a leg formed from the first printed circuit board.

Optionally, at least a portion of the one or more legs and matching slots are coated with conductive material.

Optionally, at least a portion of the pre-defined shape is plated with conductive material.

Optionally, first and second printed circuit boards are connected substantially perpendicular to each other.

Optionally, at least one of the first and second printed circuit board is plated with a material that can be used as a heat sink.

Optionally, the material is cooper or aluminum.

Optionally, the at least one second printed circuit board includes a plurality of vias operative to dissipate heat from the at least one lighting module.

Optionally, the lighting unit is adapted for auto-assembly. An aspect of some embodiments of the present invention provides an LED lighting unit comprising a printed circuit board adapted to provide electrical connection between at least one LED lighting module and a power converter, at least one LED lighting module mounted on the printed circuit board and wherein the printed circuit board includes a plurality of vias positioned around the at least one LED lighting module and adapted to dissipate heat from the at least one LED lighting module.

Optionally, the diameter of at least a portion of the vias is 0.3 mm or less.

Optionally, the vias are open vias.

Optionally, the printed circuit board includes at least one thermal pad and wherein the at least one LED lighting module is mounted over the thermal pad.

Optionally, the at least one thermal pad is in conductive communication with at least a portion of the plurality of vias positioned around the at least one LED lighting module.

Optionally, the printed circuit board includes two thermal pads for each LED lighting module and wherein the thermal pads are additionally used to electrically connect the LED lighting module to the power converter.

Optionally, the plurality of vias positioned around the at least one LED lighting module occupies an area of at least 8 cm².

Optionally, the plurality of vias positioned around the at least one LED lighting module includes a matrix pattern of at least 10 vias per 1 cm².

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified circuit diagram of a resonant fly-back converter in accordance with some embodiments of the present invention;

FIG. 2 shows exemplary current flow through a fly-back converter circuit during a magnetizing period in accordance with some embodiments of the present invention;

FIG. 3 shows exemplary current flow through a fly-back converter circuit during freeze-mode period in accordance with some embodiments of the present invention;

FIG. 4 shows exemplary current flow through a fly-back converter circuit during rise-time period in accordance with some embodiments of the present invention;

FIG. 5 shows exemplary current flow through a fly-back converter circuit during a magnetizing period of the resonant fly-back converter in accordance with some embodiments of the present invention;

FIG. 6 shows exemplary current flow through a fly-back converter during a resonance period of the resonant fly-back converter in accordance with some embodiments of the present invention;

FIG. 7 is a simplified flow chart of an exemplary method for controlling PWM switching of a resonant fly-back power converter for powering one or more LED lighting modules in accordance with some embodiments of the present invention;

FIGS. 8A and 8B are simplified wave form diagrams of current on a primary and secondary winding of a resonant fly-back converter in accordance with some embodiments of the present invention;

FIGS. 9A and 9B are a simplified waveform diagram of input voltage to the first and second switching elements of a resonant fly-back converter in accordance with some embodiments of the present invention;

FIG. 10 is a simplified waveform diagram of a voltage drop across the second switching element of a resonant fly-back converter in accordance with some embodiments of the present invention;

FIGS. 11A-11D are simplified waveform diagram of input voltage to the first and second switching elements and current on a primary and secondary winding of a resonant fly-back converter for exemplary variable frequency pulsing in accordance with some embodiments of the present invention;

FIGS. 12A, 12B and 12C are simplified diagrams of two piece PCB structure for an LED lighting unit with a screw head formed from a PCB for attachment to a screw socket in accordance with some embodiments of the present invention;

FIG. 12D is a simplified diagram of a PCB surface on which the LED lighting modules are mounted in accordance with some embodiments of the present invention;

FIGS. 13A and 13B are simplified diagrams of a two piece PCB structure showing slits on one of the PCB structures for a perpendicular connection with the another PCB in accordance with some embodiments of the present invention;

FIGS. 14A and 14B are simplified diagrams of a two piece PCB structure for an LED lighting unit with a pin head for attachment with a pin socket in accordance with some embodiments of the present invention; and

FIGS. 15A and 15B are simplified diagrams of a multi-piece PCB structure of an LED lighting unit in accordance with some embodiments of the present invention.

### DESCRIPTION OF SPECIFIC EMBODIMENTS OF THE INVENTION

The present invention relates to power converters and LED lighting units, and more particularly to power converters for LED lighting units.

An aspect of some embodiments of the present invention is the provision of a resonant fly-back converter including a freeze-mode period operative to clamp the current on a primary winding for a pre-determined time prior to discharging current to the coupled secondary winding. According to some embodiments of the present invention, the pre-determined time corresponds to a desired delay required to synchronize switching with a first valley of a resonant oscillating voltage.

According to some embodiments of the present invention, the resonant fly-back converter operates with two PWM switching units and/or elements controlling a time period over which the primary winding is magnetized and a time period over which current on a primary winding is clamped for each pulse repetition cycle of the fly-back converter. The present inventor has found that a time period between disconnecting the primary winding from an input voltage and a first valley of the resonant oscillating voltage can be predicted (pre-determined) based on known values and/or parameters of the circuit elements and used to synchronize switching with the first valley. Additionally, the present inventor has found that the current on the primary winding can be clamped to delay a resonance period of the circuit so that the predicted zero crossing voltage at the first valley is synchronized and/or coincides with PWM switching. It is advantageous to synchronize switching with the first valley during resonance since it is the lowest voltage valley point. This results in the lowest losses. According to some embodiments of the present invention, a pulse width and/or on-time of one of the switching units defines the magnetizing period of the transformer and/or inductor (including the primary winding) and a pulse width and/or on-time of the other switching unit defines a period covering both the magnetizing period and the freeze-mode period over which the current on the primary winding is clamped.

According to some embodiments of the present invention, PWM switching is operated at a constant frequency, e.g. switching frequency and/or pulse repetition frequency, and the width of the pulse is modulated to control a voltage output of the converter, e.g. to obtain a desired voltage output. According to some embodiments of the present invention, freeze-mode period is adjusted for different magnetizing periods so that switching coincides with the predicted time period of the first valley of the voltage during resonance of the input circuit.

Alternatively, in some exemplary embodiments, modulation is provided by varying the switching frequency while the pulse width for defining the magnetizing period is kept constant. Typically, in such a case the freeze-mode period is adjusted as a function of the switching frequency so that the predicted time period of the first valley of the voltage during resonance of the input circuit corresponds with PWM switching. Optionally, modulation is provided by varying both the switching frequency and the pulse width defining the magnetizing period.

According to some embodiments of the present invention, the fly-back converter operates in discontinuous mode and the primary winding is completely demagnetized at the end of a commutation cycle. By discharging the primary winding at the end of a commutation cycle, e.g. prior to switching PWM switching unit on, saturation and over loading while the primary winding is connected to a power source for loading can be prevented. One of the advantages of operating in discontinuous mode is that power factor correction is obtained.

An aspect of some embodiments of the present invention is the provision of a mechanical structure for a LED lighting module constructed from a PCB panel that can be mechanically and electrically connected to an AC socket. Optionally, the PCB panel is shaped, e.g. cut, to accommodate screwing the PCB structure through the threads of a screw socket. Optionally, the PCB is shaped, e.g. cut, to accommodate plugging the PCB structure into a pin socket. The cut shape is preferably coated with conducting material to provide for electrical connection with the electrical elements mounted on the PCB, e.g. to enable auto-assembly during soldering of the LEDs.

According to some embodiments of the present invention, an AC-DC converter and the DC-DC converter are mounted on the PCB structure. According to some embodiments of the present invention, one or more additional PCBs housing the LED elements are fitted, preferably perpendicularly, onto the first PCB, e.g. the PCB connected to the AC socket. In some exemplary embodiments, the first and at least one second PCB is fitted into each-other through a series of slots on one PCB with matching protrusions on the other PCB. Optionally, the slots include a prong constructed from PCB that is structured like a cantilever beam, providing a spring force for fixedly securing the PCB to each other. Optionally, gluing or soldering is used to secure the protrusions in the slots and/or provide electrical connection between the first and at least one second PCB. Optionally, gluing is not required.

The present inventors have found that by mechanically structuring the LED lighting unit from PCBs, assembly of the LED lighting module can be fully automated and manufacturing cost can be reduced. Additionally, by eliminating the socket connectors traditionally used to connect to the AC socket to the AC line, the bill of materials can be reduced.

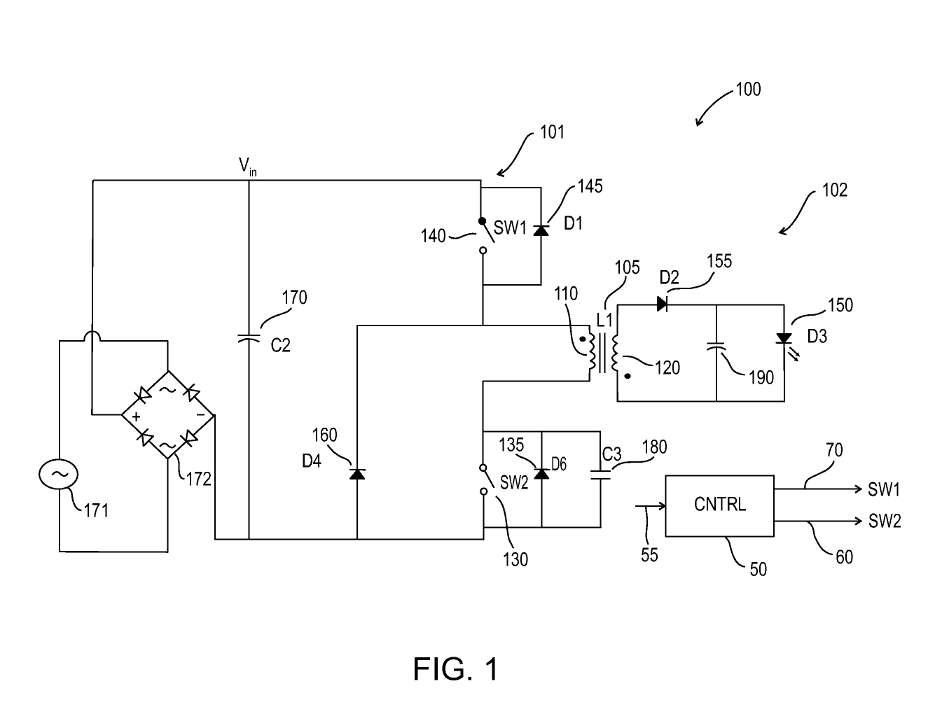

Reference is now made to FIG. 1 showing a simplified circuit diagram of a resonant fly-back converter in accordance with some embodiments of the present invention. According to some embodiments of the present invention, a resonant fly-back converter circuit 100 includes an input circuit 101 operative to supply power to an output circuit 102 including a load. Optionally, one or more LED lighting modules 150 constitute the load of the circuit. Typically, each LED lighting module includes one or more LEDs.

According to some embodiments of the present invention, resonant fly-back converter 100 is a DC/DC converter receiving a near constant voltage input Vᵢₙ to input circuit 101 that supplies regulated power to output circuit 102 using PWM switching with two switching units, a first switching element 130 and a second switching element 140. According to some embodiments of the present invention, constant voltage input Vᵢₙ is derived from an AC/DC converter and/or bridge 172, operative to provide a substantially steady DC from AC house current 171. Optionally, other voltage sources providing 85-277 VAC and/or a DC source can be used with fly-back converter 100.

According to some embodiments of the present invention, power is transferred from the input circuit 101 to the output circuit 102 through fly-back transformer, inductor and/or choke 105 including primary winding 110 (on the input side of the circuit) and secondary winding 120 (on the output side of the circuit). Typically, as in known fly-back converters, primary winding 110 and secondary winding 120 act like two magnetically coupled inductors and do not conduct simultaneously. Current is either present on primary winding 110 or secondary winding 120, but not on both.

According to some embodiments of the present invention, each of switching elements 130 and 140 is connected to a terminal of the primary winding 110 and a terminal of the input voltage Vᵢₙ and operates to control magnetizing of transformer 105. The ends of the primary and secondary are dotted to indicate relative polarity. Typically, the dotted end of primary winding 110 is connected to the positive side of Vᵢₙ. According to some embodiments of the present invention, switching elements 130 and 140 are MOSFET switches or the like that can operate at a high switching frequency, e.g. around 100 KHz. Typically, switching units 130 and 140 are integrated with diode 135 and 145 respectively in parallel with each of the switches elements. According to some embodiments of the present invention, a diode 160 is connected to primary winding 110 and its function will be described in herein below.

According to some embodiments of the present invention, fly-back converter 100 includes at least one input capacitor 170 (C₂) connected across source Vᵢₙ and at least one resonance and/or load capacitor 180 connected across second switching element 130. During operation of converter 100, input capacitor 170 and resonance capacitor 180 (C₃) are alternately charged and discharged based on the direction of current flow through fly-back converter circuit 100 as will be described in detail herein below. In some exemplary embodiments, resonance capacitor 180 has a capacitance between 100 pF-10 nF, e.g. 500 pF and input capacitor 170 has a capacitance between 100 nF-100 μF, e.g. 400 nF for a 6 Watt converter. Typically, input capacitor 170 functions as a filter for filtering spikes to and from voltage source, e.g. mains 171. Typically, voltage across capacitor 170 follows the input voltage, e.g. rectified sine wave from bridge 172.

According to some embodiments of the present invention, a controller 50 controls and synchronizes switching of switching elements 130 and 140 with control signals 60 and 70 respectively. Optionally, control signals 60 and 70 outputted to switching elements 130 and 140 are based on one or more inputs 55 to controller 50. In some exemplary embodiments, one or more inputs 55 include a dimming level command indicating an intensity level required from LED module 150. Optionally the dimming command is generated from the AC level supplying power 171. Thus, a dimmer, as used for incandescent lamps can be used to control the light output of the LEDs. Optionally, the dimming level command is a digital command and may be received by a switch or remote control unit for operating the LED lighting module.

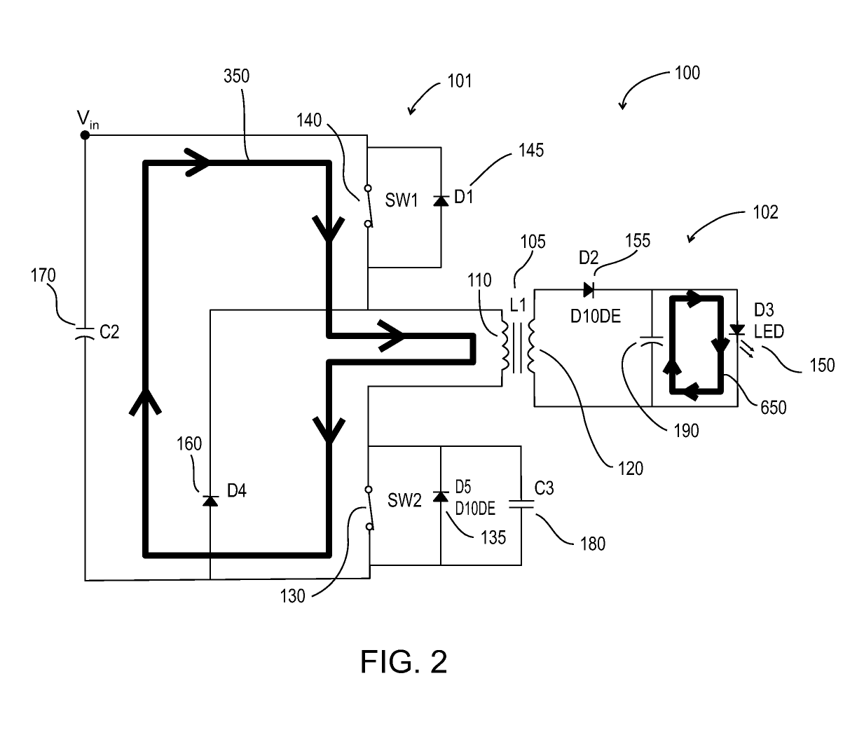

Reference is made to FIGS. 2-6 showing exemplary current flow through a fly-back converter circuit during different periods of a commutation cycle of fly-back converter circuit 100. In some exemplary embodiments, a commutation cycle includes a magnetizing period, a freeze-mode period, a rise-time period, a demagnetizing period, and a resonance period. According to some embodiments of the present invention, duration of the freeze-mode period is controlled to coordinate PWM switching with near zero near zero voltage across first and second switching elements 130 and 140.

FIG. 2 shows exemplary current flow through a fly-back converter circuit during a magnetizing period in accordance with some embodiments of the present invention. According to some embodiments of the present invention, during a magnetizing period both switching elements 130 and 140 are closed (conducting) and primary winding 110 is connected to Vᵢₙ and a current flow 350 flows from voltage source Vᵢₙ through primary winding 110 and magnetizes transformer 105 (induces a flux in transformer 105). Typically, voltage on capacitor 170 is constant during this period.

During the magnetizing period, current flow 650 from charge in capacitor 190 accumulated from a previous cycle powers the load, e.g. the LED lighting modules 150. Once transformer core 105 is charged to a desired amount set by the width of the PWM, Vᵢₙ is disconnected from primary winding 110, by opening switch 140, and the magnetizing period is terminated. Typically, a magnetizing period corresponds to a width of a PWM pulse of switching unit 140 which is defined by the following equation:

T_{MAG}=D×Ts; (Equation 1)

where:
T_{MAG} is the magnetizing period,
D is the duty cycle of the magnetizing period, and
Tₛ is a period of one switching cycle.

According to some embodiments of the present invention, while primary winding 110 is conducting, current in secondary winding 120 is blocked due to diode 155 that is reverse-biased (dotted end potential being higher). During this period, capacitor 190 supplies current, e.g. uninterrupted current, to LED modules 150. Secondary winding 120 begins to conduct in response to breaking of the current path of primary winding 110. Voltage polarities across the primary and secondary windings reverse and diode 155 becomes forward biased. Current flow supplied by secondary winding 120 charges capacitor 190 and supplies current to the load, e.g. LED lighting modules 150. Typically, capacitor 155 is sufficiently large to that its voltage does not change appreciably in a single switching cycle but over a period of several cycles, the capacitor voltage builds up to a substantially steady state value.

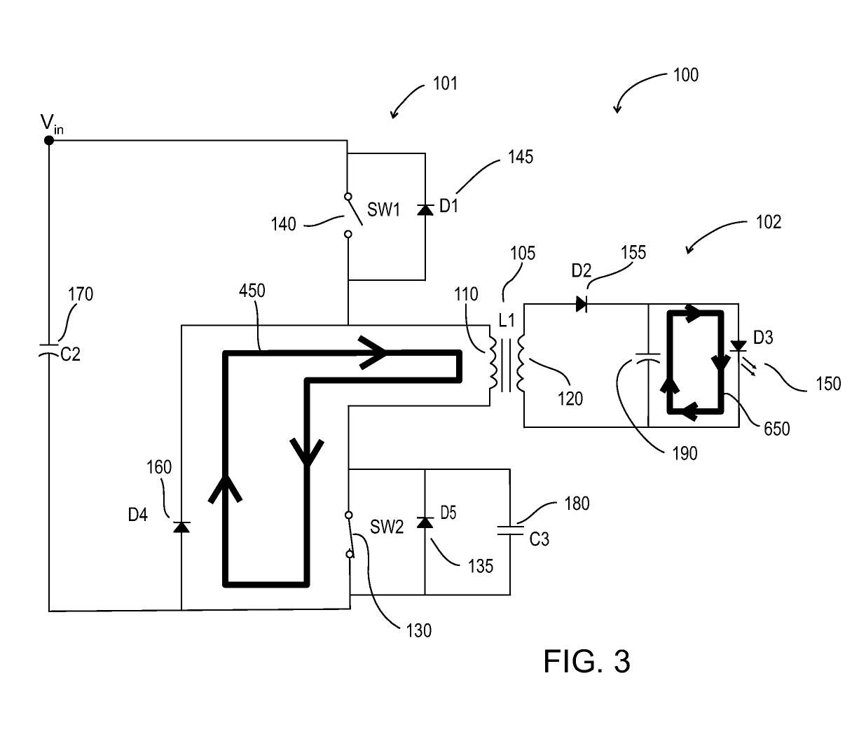

FIG. 3 shows exemplary current flow through a fly-back converter circuit during freeze-mode period in accordance with some embodiments of the present invention. According to some embodiments of the present invention switching element 140 operates to disconnect Vᵢₙ from primary winding 110 and directing current flow through a diode 160 during a freeze-mode period of fly-back converter 100.

According to some embodiments of the present invention, freeze-mode period is initiated directly after the magnetizing period and is implemented to clamp current on primary winding 110 to substantially the fully charged current for a pre-determined period of time. According to some embodiments of the present invention, freeze-mode period is activated by opening first switching element 140 while maintaining second switching element 130 closed so that current flow 450 through primary winding 110 is maintained and is directed through diode 160 that is forward biased. According to some embodiments of the present invention, opening first PWM switching element 140 disconnects primary winding 110 from Vᵢₙ, but since second switching element 130 is still closed, current flow 450 continues to flow in a same direction and through diode 160. According to some embodiments of the present invention, as long as second switching element 130 is closed, the current through the primary and the energy stored in transformer 105 remains constant and the energy is prevented from discharging onto secondary winding 120. It is noted that over an extended period, current flow 450 will be extinguished by power lost in resistances of elements in circuit 101. Typically, the clamping and/or freeze-mode period lasts between 100 nsec-10 μsec and losses due to resistance are small and/or acceptable. According to some embodiments of the present invention, controller 50 terminates freeze-mode period by opening second PWM switching element 130 (e.g. ending input pulse 60 of switching element 130). According to some embodiments of the present invention, the width of pulses of switching unit 130 defines the freeze-mode period.

According to some embodiments of the present invention, controller 50 is operative to determine duration of a desired freeze-mode period based on one or more parameter values of converter circuit 100 stored in controller 50 and/or in memory associated with controller 50 and/or based on a magnetizing level of transformer 105. Optionally, duration of a freeze-mode period (a delay period for synchronizing switching with a first valley of resonant voltage) is stored in controller 50 and/or in memory associated with controller 50. In some exemplary embodiments, one or more inputs 55 include a delay command indicating duration of a freeze-mode period required.

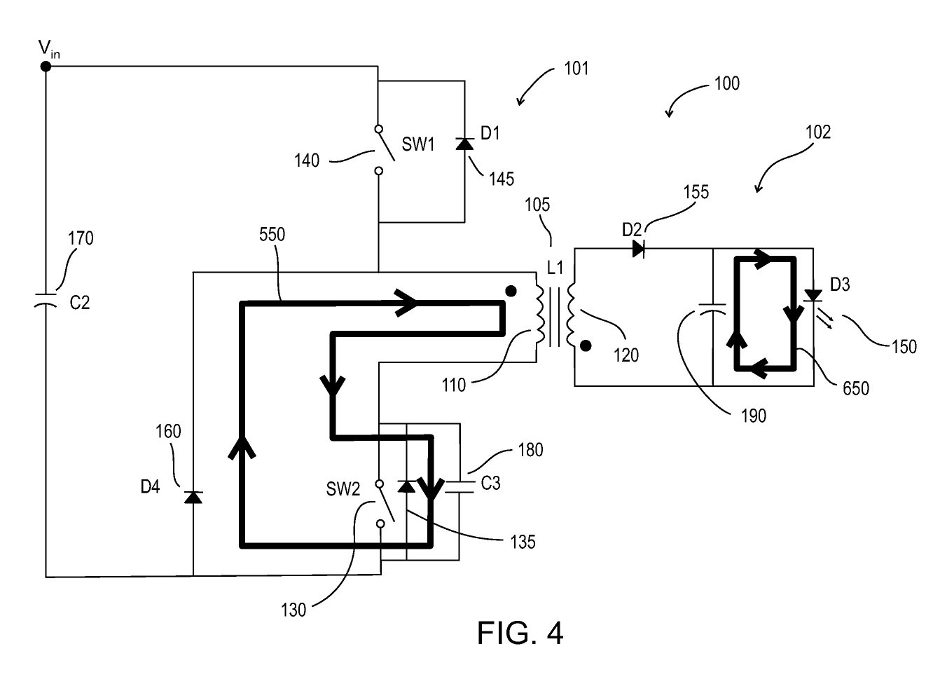

FIG. 4 shows exemplary current flow through a fly-back converter circuit during rise-time period in accordance with some embodiments of the present invention. According to some embodiments of the present invention, rise-time period is initiated by opening second switching element 130. Current flow 550 is directed to the resonance capacitor 180 and charges the resonance capacitor 180 to a voltage level matching a voltage developed across primary winding 110. Typically, transition between rise-time period and the following demagnetizing period is spontaneous. The duration of rise-time period and onset of demagnetizing period can be pre-determined base on parameters and/or specification of the winding and resonance capacitor as well as other circuit elements and is defined by the following equation:

Tᵣᵢₛₑ=(C₃×L_{M}dI_{LM}/dt)/I_{LM} Equation (2)

where:
Tᵣᵢₛₑ is the duration of the rise-time period;
C₃ is the capacitance of the resonance capacitor 180;
L_{M} is inductance of primary winding 110; and
I_{LM} is current flow 450 flowing through primary winding 110.

Typically, the inductance as measured in primary winding 110 is the actual inductance in primary winding 110 plus a leakage inductance and is defined by:

L_{T}=L_{M}+L_{L} Equation (3)

where:
L_{T} is the total inductance as measured; and
L_{L} is the leakage inductance.

Typically, the leakage inductance is the inductance measured in response to shorting secondary winding 120.

Optionally, Tᵣᵢₛₑ is determined from one of Equations (4) or (5) defined by:

$$\begin{matrix}{T}_{rise} = \frac{1}{2} \times [ ( \frac{{C}_{3} \times {V}_{out} \times {L}_{T}}{\frac{{N}_{sec}}{{N}_{pri}} \times {V}_{i n} \times D \times {T}_{s}} ) + \sqrt{{( \frac{{C}_{3} \times {V}_{out} \times {L}_{T}}{\frac{{N}_{sec}}{{N}_{pri}} \times {V}_{i n} \times D \times {T}_{s}} )}^{2}} + 4 \times {C}_{3} \times {L}_{L} ] & Equation ( 4 ) \\ {T}_{rise} = {C}_{3} \times {L}_{T} \times {sin}^{- 1} ( \frac{{C}_{3} \times {L}_{T}^{2} \times {V}_{out}}{{L}_{M} \times {V}_{in} \times D \times {T}_{s} \times \frac{{N}_{sec}}{{N}_{pri}}} ) & Equation ( 5 )\end{matrix}$$

where:
N_{sec} is the number of loops in secondary winding 120; and
Nₚᵣᵢ is the number of loops in primary winding 110.

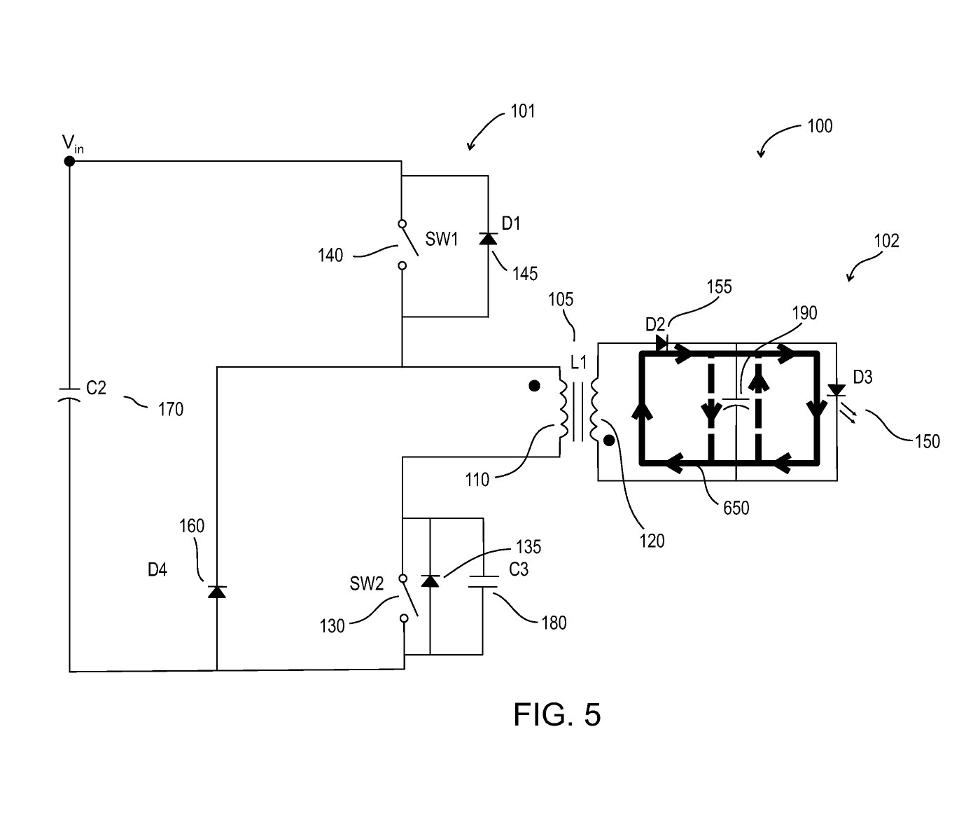

FIG. 5 shows exemplary current flow through a fly-back converter circuit during a demagnetizing period of the resonant fly-back converter in accordance with some embodiments of the present invention. After charging of resonance capacitor 180, the primary winding current path is broken and according to laws of magnetic induction, the voltage polarities across the windings reverse. Reversal of voltage polarities makes diode 155 forward biased and secondary winding 120 substantially immediately starts conducting and charging capacitor 190 as well as powering the load, e.g. LED lighting modules 150 with current flow 650. Typically, capacitor 190 is sufficiently large such that its voltage does not change appreciable in a single switching cycle but over a period of several cycles after initiation, the capacitor voltage builds up to its steady state value.

During the demagnetizing period both second switching element 130 and first switching element 140 are open and Vᵢₙ is disconnected from primary winding 110. The demagnetizing period lasts until current flow 650 through secondary winding 120 is expended and transformer 105 is demagnetized (when operating in discontinuous mode). Typically the duration of the demagnetizing period is a function of the current flow 650 and the power output of the load, e.g. LED lighting modules 150.

T_{DEMAG}=Vᵢₙ/(a×Vₒᵤₜ))×D×T_{MAG} Equation (6)

a²=L_{Mpri}/L_{Msec} Equation (7)

where:
Vₒᵤₜ is voltage output across secondary winding,
L_{Mpri} is inductance of primary winding,
L_{Msec} is inductance of secondary winding,
T_{MAG} is the magnetizing period, and
D is the duty cycle of the magnetizing period.

Optionally, the duration of the demagnetizing period is determined from the following equation:

$${T}_{DEMAG} = \frac{{V}_{in} \times D \times {T}_{s}}{{V}_{out}} \times \frac{{N}_{sec}}{{N}_{pri}} \qquad Equation ( 8 )$$

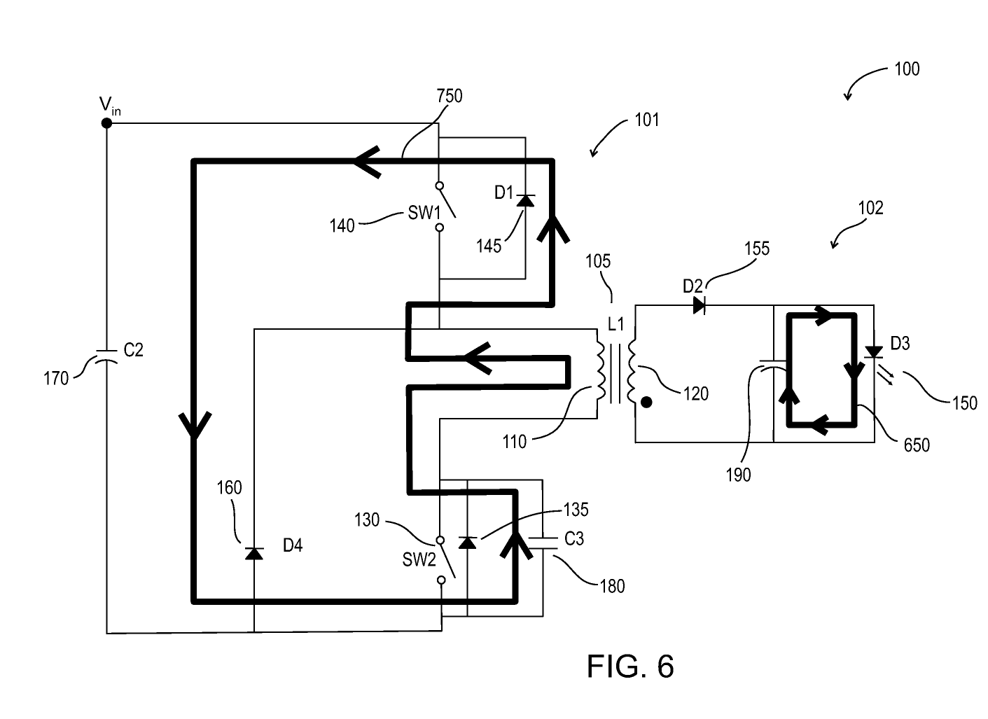

FIG. 6 shows exemplary current flow through a fly-back converter showing current flow during a resonance period of the resonant fly-back converter in accordance with some embodiments of the present invention. After demagnetizing of transformer 105, a resonant period is triggered in input circuit 101 and current flow 750 in input circuit 101 is in a reversed direction. Charge accumulated in resonance capacitor 180 is discharged and flows through primary winding 110 and the circuit begins to resonate. According to some embodiments of the present invention, switching units 130 and 140 are timed to close (conduct) and begin a new commutation cycle at a first valley of resonating voltage across resonance capacitor 180 corresponding to a time when the voltage across lower PWM switching element is at a minimum, e.g. at 0 volts or at a near minimum. According to some embodiments of the present invention, the resonance period lasts for a few nanoseconds up to some 10 s of nanoseconds before the next commutation cycle begins and is defined by the following equation:

T_{RES}=1/(4*F_{RES}) Equation (9)

where:
T_{RES} is the duration of resonance period; and
F_{RES} is the resonance frequency.

Optionally, the resonance period is determined from the following equation:

T_{RES}=π×\sqrt{L_{T}×C_{T}} Equation (10)

where:
C_{T} is the total capacitance that appears on the transformer terminal during resonance.

Typically, C_{T} is defined from the following equation:

$${C}_{T} = \frac{1}{\frac{1}{{C}_{2}} + \frac{1}{{C}_{3}}} \qquad Equation ( 11 )$$

According to some embodiments of the present invention, the duration of the desired freeze-mode period is defined so that a first valley of the resonance coincides with the beginning of the new commutation cycle based on the following equation:

T_{freeze}=Tₛ−T_{MAG}−Tᵣᵢₛₑ−T_{DEMAG}−T_{RES} Equation (12)

Typically T_{freeze} is a function of the magnetizing period T_{ON} (assuming a constant Vᵢₙ) controlled by controller 50 and is adjusted accordingly.

According to some embodiments of present invention, duration of rise-time period, demagnetize period and resonance period (up to first valley) can be pre-determined based on specifications of circuit elements of fly-back converter 100 and/or during calibration of the converter. According to some embodiments of the present invention, the period that the circuit is maintained in freeze-mode period is defined so that the commutation cycle ends when the voltage across the second switching element 130 is at minimum or near minimum. Typically, the first valley point of the voltage is the lowest and is therefore used to define the period of freeze-mode period. Typically, voltage across first switching element 140 is likewise minimum or near minimum due to the developing voltage on primary inductor 110.

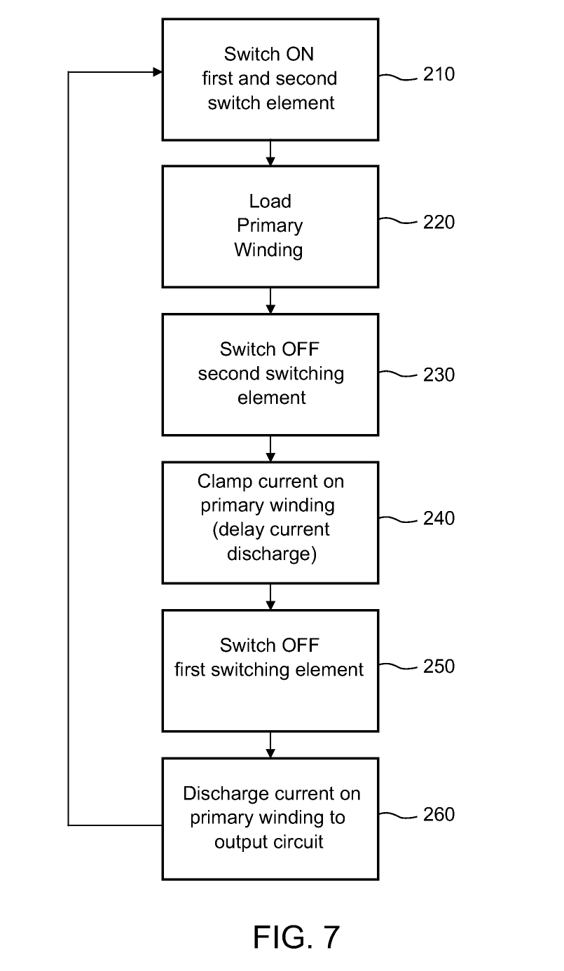

Reference is now made to FIG. 7 showing a simplified flow chart of an exemplary method for controlling PWM switching of a resonant fly-back power converter for powering one or more LED lighting modules in accordance with some embodiments of the present invention. According to some embodiments of the present invention controller 50 initiates pulsing (and/or switching) of switching elements 130 and 140 in synchronization (block 210). According to some embodiments of the present invention controller 50 pulses switching elements 130 and 140 at a constant frequency. Optionally in other embodiments of the present invention, controller 50 pulses switching elements 130 and 140 at a varying frequency.

According to some embodiments of the present invention, in response to activation of switching elements 130 and 140, e.g. closing switching elements 130 and 140, transformer 105 is magnetized by current flowing through primary winding 110 from Vᵢₙ (block 220). According to some embodiments of the present invention, charging of primary winding 110 continues until controller 50 switches off first switching element 140. Typically, a period over which first switching element 140 is activated defines a charge level of primary winding 110. According to some embodiments of the present invention, controller 50 controls a charge level and/or a period for charging primary winding 110. In some exemplary embodiments, a period of time during which first switching elements 140 is activated is based on dimming level command and PWM control provides for different diming levels for LED module 150. Optionally, dimming is not provided and PWM control of switching element 140 provides for maintaining a constant output intensity of LED lighting modules 150 over an extended period of time or a constant voltage supply to LED lighting modules 150.

According to some embodiments of the present invention, in response to opening of switching element 140 while maintaining second switching element 130 closed (conducting), primary winding 110 is disconnected from input voltage Vᵢₙ and current flow is clamped on primary winding 110. This period is referred to as a freeze-mode period and is operable to controllably delay transfer of current to secondary winding 120. According to some embodiments of the present invention, transfer of current flowing through primary winding is delayed over a defined period to coordinate simultaneous switching of first switching element 140 and second switching element 130 with a first valley of a resonance period of circuit 101. According to some embodiments of the present invention, the defined period is pre-determined based on known parameters and characteristics of the resonant fly-back converter 100.

According to some embodiments of the present invention, at a termination of the defined freeze-mode period, second switching element 130 is opened, e.g. switched off (block 250). According to some embodiments of the present invention, in response to both second switching element 130 and first switching element 140 being switched off, current flowing through primary winding 110 is transferred to output circuit 102 for charging capacitor 190 and powering LED module 150 (block 260). Typically, discharging current in primary winding 110 initiates a resonance period in input circuit 101. According to some embodiments of the present invention, an additional commutation cycle is initiated by switching ON first and second switching elements (210). According to some embodiments of the present invention, initiation of the commutation cycle coincides with a predicted time of a first valley of resonating voltage of circuit 101 of the previous commutation cycle.

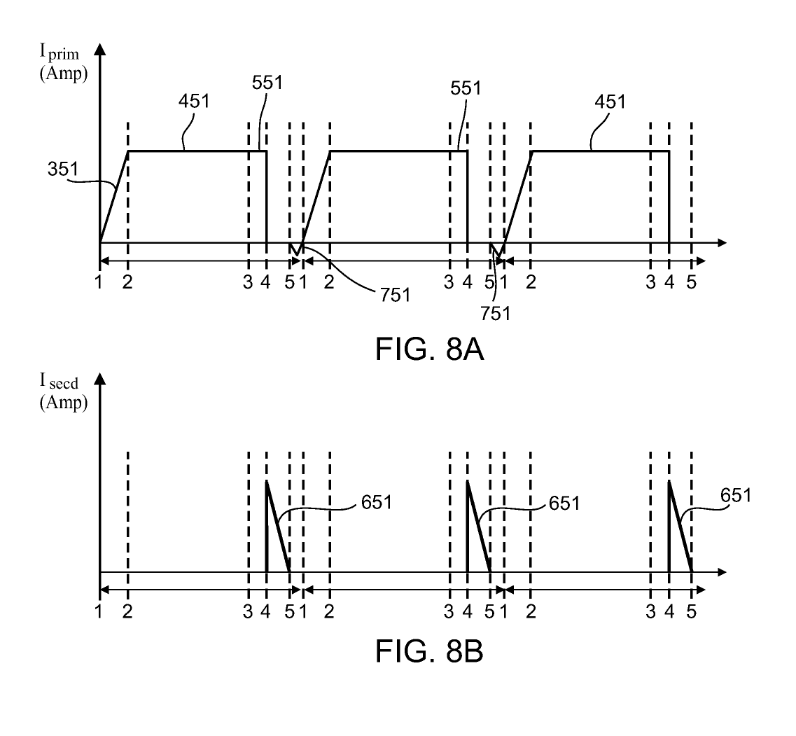

Reference is now made to FIGS. 8A and 8B showing simplified wave form diagrams of current on a primary and secondary winding of a resonant fly-back converter in accordance with some embodiments of the present invention. According to some embodiments of the present invention, during the magnetizing period (between time reference points 1 and 2), the primary winding 110 is charged with current 351 for a controllable time up to a desired level 451. During magnetizing period both switching element 130 and switching element 140 are turned on (closed) and the transformer/inductor 105 is magnetized from Vᵢₙ. The current level 451 reached at the end of magnetizing period (reference point 2) is defined by the width of the PWM signal provided by the first switching element 140. According to some embodiments of the present invention, the freeze-mode period (occurring between time reference points 2 and 3) is initiated by opening first switching element 140 while maintaining second switching element 130 closed. During freeze-mode period, the current level 451 on primary inductor 110 is maintained at a constant and/or near constant level and is not discharged to the output circuit 102. Typically, freeze-mode period is maintained between 100 nsec-10 μsec.

According to some embodiments of the present invention, at the end of the designated freeze-mode period, the second switching element is opened and rise-time period (occurring between reference points 3 and 4) is initiated. During the rise-time period, some current is lost in charging resonance capacitor 180 to a voltage level matching a leakage voltage associated with primary winding 110. Typically, the current reduction on primary winding is small and/or insignificant. Once resonance capacitor 180 is charged, the primary winding current path is broken and the voltage polarities across the primary and secondary windings reverse.

Referring now to FIG. 8B, reversal of voltage polarities due to the broken current path for primary winding 110 makes diode 155 forward biased and secondary winding 120 substantially immediately starts conducting. Current 651 transferred to output circuit 102 through secondary winding 120 (during demagnetizing period occurring between time reference points 4 and 5) is used to charge capacitor 190 and to power LED lighting modules 150. Once current 651 on the secondary inductor 120 is fully dissipated, voltage across primary winding 110 drops and input circuit 101 enters a resonance period (occurring between time reference points 5 and 1) where the direction of current is reversed and primary inductor is alternatively charged and discharged with charge stored in resonance capacitor 180. According to some embodiments of the present invention, a new commutation cycle is timed to begin at first zero-crossing voltage across second switching element 130 during the resonance period. At the initiating of a new commutation cycle, current 330 is again reversed and the primary inductor is charged from power source Vᵢₙ. In some exemplary embodiments, the commutation cycle is initiated while current on the primary winding is depleted (discontinuous mode).

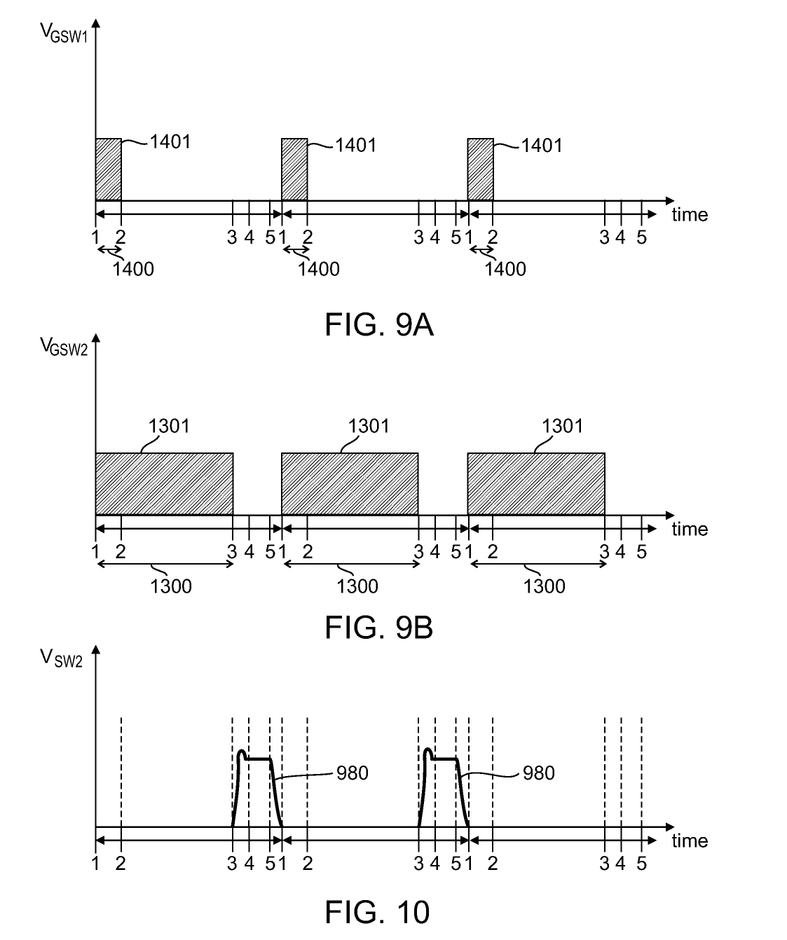

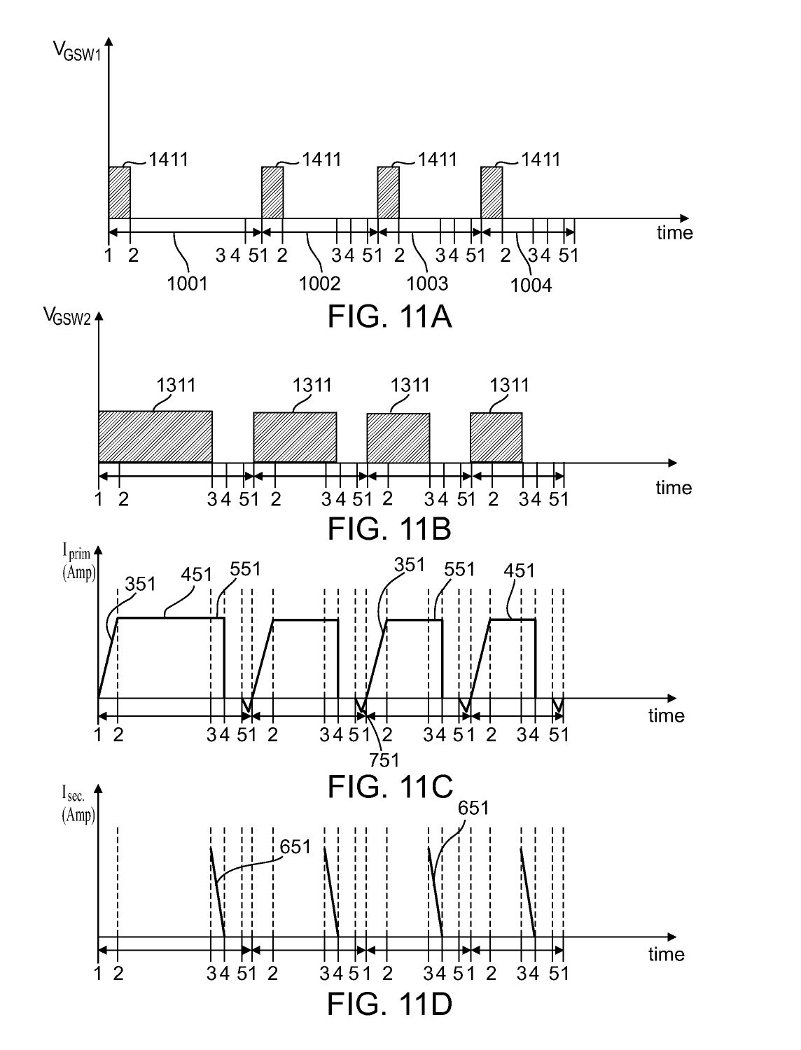

Reference is now made to FIG. 9 showing a simplified waveform diagram of input command to switching elements of a resonant fly-back converter and to FIG. 10 showing simplified waveform diagram of a voltage drop across second switching element 130 of a resonant fly-back converter, both in accordance with some embodiments of the present invention. According to some embodiments of the present invention pulsing 1401 of first switching element 140 and pulsing 1301 of second switching element 140 is synchronized to occur simultaneously and at a same and constant frequency. However, the duty cycle of pulse 1301 is longer than that of pulse 1401. The difference between the length of pulses 1301 and 1401 defines the freeze-mode period of circuit 100.

According to some embodiments of the present invention, first switching element 140 is activated, e.g. conducting over a magnetizing period 1400 (between time reference points 1 and 2) and second switching element 130 is activated (conducting) over a magnetizing and freeze-mode period 1300 between time reference points 1 and 3. According to some embodiments of the present invention, both second switching element 130 and first switching element 140 are turned on (conducting) at time reference point 1 to initiate the magnetizing period, where the input circuit 101 is connected to Vᵢₙ and primary winding 110 is charged. According to some embodiments of the present invention, at the end of the loading period, e.g. magnetizing period, first switching element 140 is opened while second switching element is maintained closed for a pre-determined freeze-mode period at the end of which second switching element 130 is also opened. Both second switching element 130 and first switching element 140 remain open until the remainder of the commutation cycle. Typically, LED lighting systems are low power system the duty cycle of magnetizing period is relatively low, e.g. less than half.

Referring now to FIG. 10, which is a simplified waveform diagram of a voltage drop across the second switching element of the resonant fly-back converter in accordance with some embodiments of the present invention. Once second switching element 130 is opened, a voltage 980 quickly builds across second switching element 130. The voltage peaks during a rise-time period (occurring between time reference points 3 and 4) of the circuit and then is maintained through demagnetizing of transformer 105 (discharging of secondary winding 120 occurs between time reference points 4 and 5). Voltage across the switch is discharged at the first valley during resonance of the input circuit 101 (resonance period occurs between time reference points 5 and 1). According to some embodiments of the present invention, the length of the freeze-mode period (occurring between reference points 2 and 3) is defined so that the end of the commutation cycle and beginning of the next commutation cycle (at time reference point 1) will correspond with a zero or near zero voltage across the second switching element 130.

It is noted that in FIGS. 8-10, three exemplary commutations cycles are shown with a constant (non-varying) time-on period for both switching elements 130 and 140 for simplicity sake only. According to some embodiments of the present invention, controller 50 is operable to alter input command to switching elements 130 and 140 overt time as required to obtain a desired output on the fly-back converter.

According to other embodiments of the present invention, fly-back converter 100 is operated at a variable switching frequency; increasing the frequency to get more output voltage and decreasing the switching frequency to get decrease output voltage to output circuit 102. In some exemplary embodiments, during variable frequency switching, the width of pulse provided by the first switching element (controlling charging of primary winding 110 during magnetizing period) is maintained constant through out all commutations cycles. Pulse width provided by the second switching element is adjusted based on the changing frequency requirement. Second switching element 140 coordinates to provide zero-crossing voltage at the point where the next commutation cycle is required to begin.

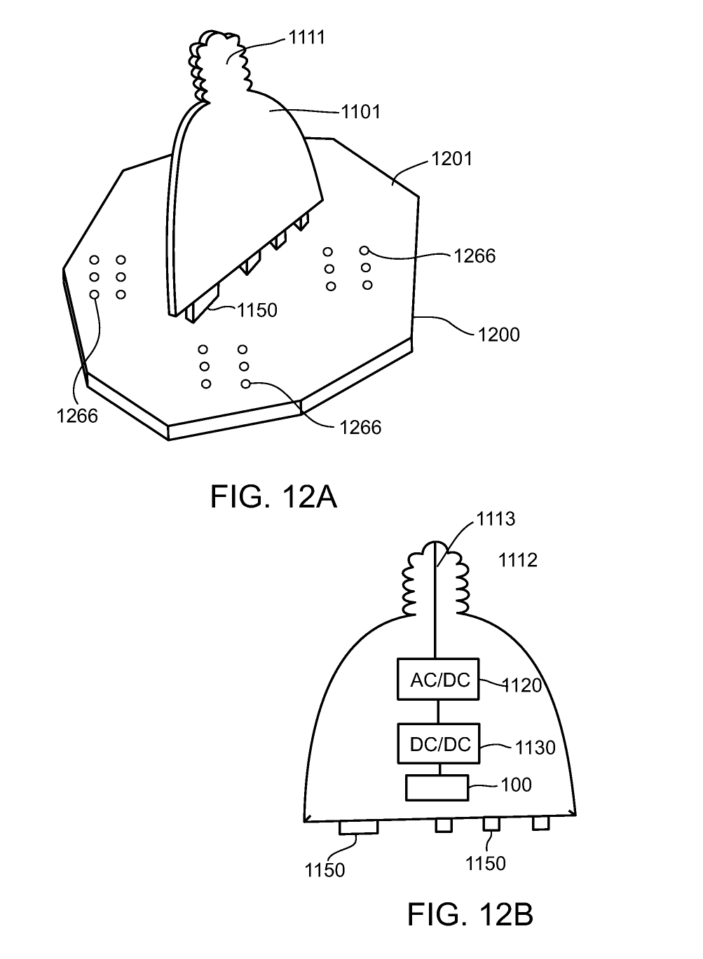

Reference is now made to FIGS. 11A-11D showing simplified time line diagrams for exemplary variable frequency pulsing in accordance with some embodiments of the present invention. According to some embodiments, first switching element 140 is pulsed with pulses 1411 at a variable frequency. In some exemplary embodiments, during variable frequency pulsing, the width of each pulse 1411, e.g. the duration of the magnetizing period (between reference points 1 and 2) is constant (the same for each commutation cycle). Typically, the input voltage is also constant. Since the magnetizing period is the same for each commutation cycle (as well as the input voltage), other periods of the commutation cycle dependent on the magnetizing level per commutation cycle can be pre-determined. In some exemplary embodiments, the duration of the rise-time period (between 3-4), the demagnetizing period (between 4-5) and the resonance period up to the first valley of voltage drop across resonance capacitor 180 are substantially constant for a constant magnetizing period (between 1-2) and can be easily determined for example by experimental observation and stored in memory. According to some embodiments of the present invention, a freeze-mode period is dynamically adjusted with changes to the pulsing (and/or switching) frequency. According to some embodiments of the present invention, adjustments to the freeze-mode period are made to coordinate initiation of a new commutation cycle (at the varying pulsing frequencies) with a predicted time for the first valley of voltage during resonance of input circuit 101.

In the example shown in FIGS. 11A-11D, the pulsing frequency is steadily increased, e.g. to increase output to LED lighting module 150 but the width of each pulse 1411 remains constant. During each commutation cycle {1001, 1002, 1003, and 1004}, current 351 on primary winding 110 is loaded to a same level 351 (FIG. 11C). As the frequency of pulses 1411 increases, distance between the pulses 1411 decreases.

In some exemplary embodiments, as shown in FIGS. 11B and 11C to compensate for the change in frequency duration of pulses 1311 from first switching unit 130 is reduced and the freeze-mode period (between 2 and 3) is likewise reduced. According to some embodiments of the present invention, the rise-time period (between 3 and 4) and demagnetizing period (between 4-5) and resonance period (between 5 and 1) is the substantially the same for each commutation cycle. According to some embodiments of the present invention, resonant fly-back converter 100 operates in discontinuous mode during variable frequency switching. As shown in FIG. 11D, the demagnetizing period (between 4-5) is practically unaffected by changes in frequency, e.g. its duration as well as its rate of current dissipation 651 is maintained constant for varying switching frequencies and secondary winding 120 is fully dissipated at the end of the demagnetizing period.

According to some embodiments of the present invention, fly-back converter 100 is operated with variable frequency switching and variable pulse widths for pulsing of first switching element 140 (varying magnetizing periods). Optionally, when operating at variable frequency switching, variable pulse widths for pulsing of first switching element 140 are used to compensate for changes in Vᵢₙ.

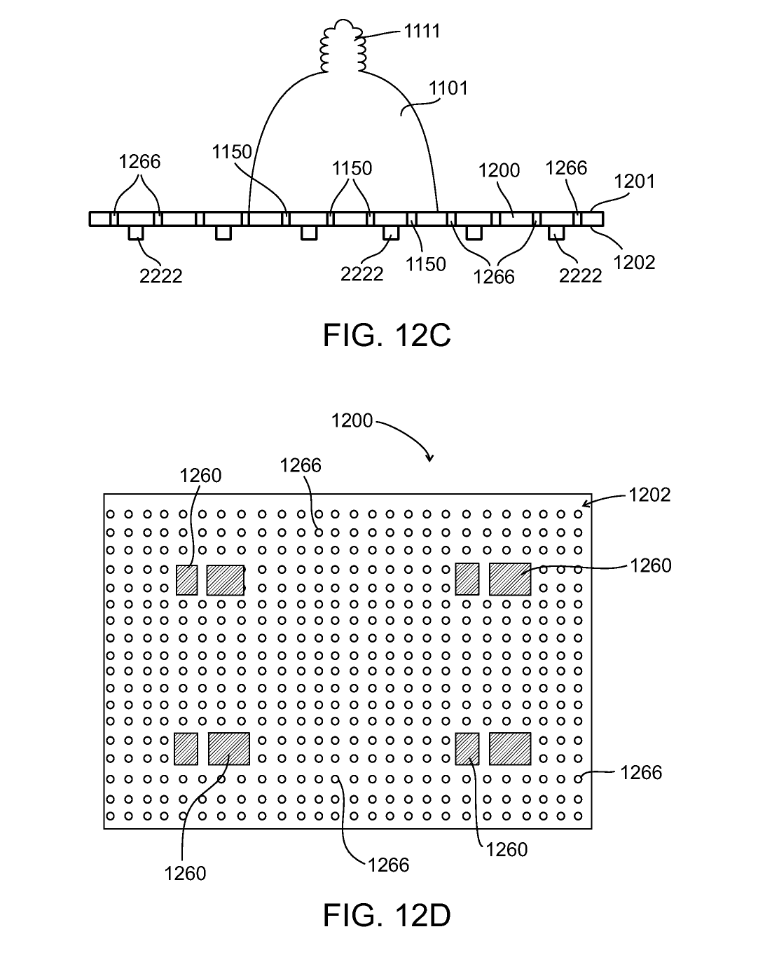

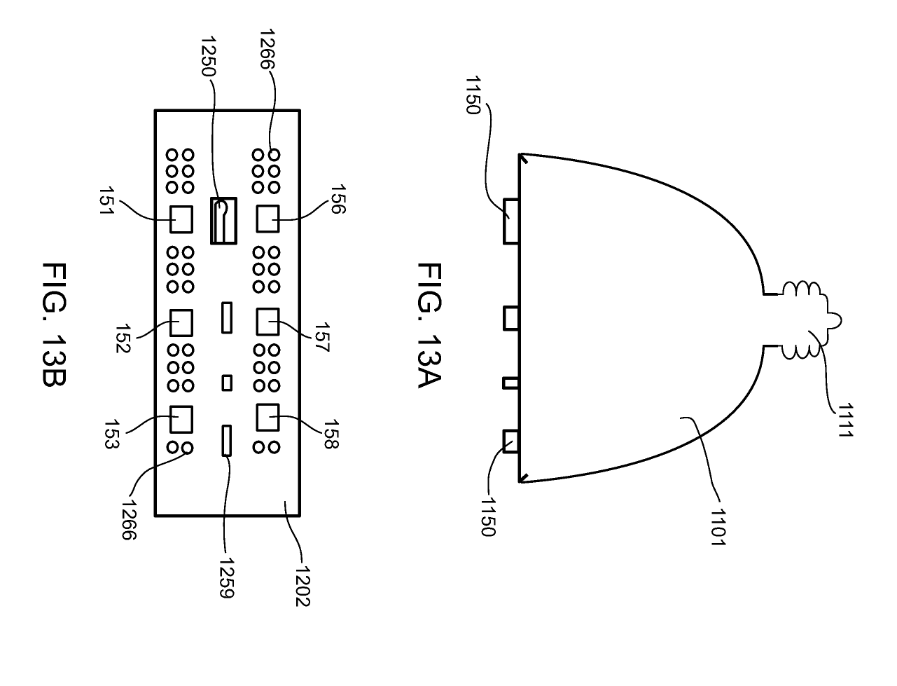

Reference is now made to FIGS. 12A, 12B and 12C showing simplified diagrams of two piece PCB structure for an LED lighting unit with a screw head for attachment to a screw socket in accordance with some embodiments of the present invention. According to some embodiments of the present invention, a lighting unit 1100 is constructed from a first PCB 1101 formed with an attachment section 1111 for connecting lighting unit 1100 to a screw lighting socket and a second PCB 1200 on which one or more LED modules are mounted.

According to some embodiments of the present invention, attachment section 1111 includes indentations 1112 that match screw threads within a conventional light socket. According to some embodiments of the present invention, indentations 1112 and/or cap cover shape 1113 are coated with conductive material that is electrically connected to components mounted on PCB 1101. Attachment section 1111 can be cut to match different dimensions of available screw sockets.

In some exemplary embodiments, an AC/DC converter unit 1120 for converting AC received from a matching socket to DC. Optionally, components providing AC/DC conversion are mounted on PCB 1101. In some exemplary embodiments a DC/DC converting unit 1130, e.g. fly-back converter 100 is mounted on PCB 1101 and is operative to regulate power received by one or more LED lighting modules.

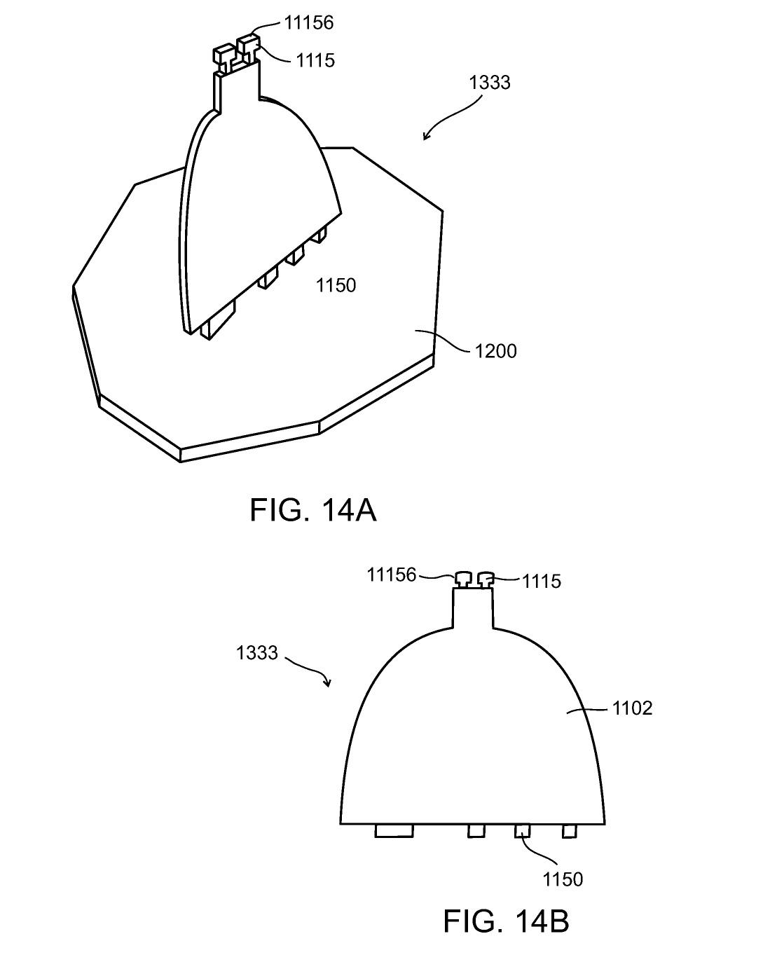

According to some embodiments of the present invention PCB 1101 is additionally formed with one or more legs 1150 for physically and/or electrically connecting PCB 1101 to PCB 1200. According to some embodiments of the present invention, one or more legs 1150 coated with conductive material to form electrical connection between PCB 1101 and 1200. According to some embodiments of the present invention, PCB 1101, attachment section 1111 and legs 1150 is formed, e.g. cut from a single PCB panel and is a continuous surface. Exemplary connecting mechanisms and methods for connecting PCB 1101 and PCB 1200 is explained in greater detail herein below for example in reference to FIGS. 13A and 13B.

According to some embodiments of the present invention, one or more LED light modules 2222 are mounted on PCB 1200 (FIG. 12C). Typically, the LED lighting modules 2222 are mounted on surface 1202 of PCB 1200 opposite surface 1201 of PCB 1200 on which PCB 1101 is positioned. Optionally, a plurality of thermal vias 1266 are introduced through PCB 1200 around each LED of the module and used to cool LED lighting module. In some exemplary embodiments, one or more electrical components in addition to LED light modules 2222 are mounted on surface 1201 and/or surface 1202 of PCB 1200. Typically, only the LEDs are mounted on surface 1202 of PCB 1200. Optionally, DC/DC converter 1130 or components associated with DC/DC converter 1130 are mounted on PCB 1200. Optionally, PCB and/or surface 1202 of PCB 1200 white and/or are colored white to increase the reflection of light from the PCB toward a target area.

Reference is now made to FIG. 12D showing a simplified diagram of a PCB surface on which the LED lighting modules are mounted in accordance with some embodiments of the present invention. According to some embodiments of the present invention, surface 1202 of PCB 1200 include conductive surfaces 1260 over which LEDs of the LED lighting modules 2222 are mounted. In some exemplary embodiments, conductive surfaces 1260 serve as a thermal pad from which heat produced by LED lighting module 2222 can be dissipated. Typically, the conductive surface 1260 is electrically connected to a conductive layer of PCB 1200 so to increase the area over which heat is dissipated. Typically, conductive surfaces 1260 also serve as conductive pads for electrically connecting LED lighting modules 2222 to circuitry of the lighting unit, e.g. for electrically connecting LED lighting modules 2222 to power. Typically, one LED is mounted over a pair of contiguous pads 1260 for electrical connection. Alternatively, elements used to electrically connect LED lighting module 2222 to the rest of the circuit is separate from thermal pad 1260 over which a LED of LED lighting module 2222 is mounted. Optionally, a material used conductive area 1260 is copper or aluminum.

According to some embodiments of the present invention, a plurality of thermal vias 1266 electrically connected to at least one conductive surface 1260 and/or in conductive contact with a LED lighting module mounted on PCB 1200 are introduced to provide a heat sink through which heat produced by LED lighting module 2222 can be dissipated. The present inventor has found that a grid of thermal vias 1266 positioned around each LED of LED lighting module 2222 may be sufficient to dissipate heat from LED lighting module 2222 without requiring an additional external heat sink. In some exemplary embodiment, each LED of LED lighting module 2222 is surrounded by a patterned array of vias 1266 spread over an area of between 8-12 cm². Optionally, the patterned of vias 1266 are positioned with a density of at least 10 vias per 1 cm². In some exemplary embodiments, a diameter of the vias is required to be 0.3 mm or less to avoid loss of illumination through the vias, e.g. to avoid illumination directed away from a target area. Optionally, the vias are not plugged and provide venting. The present inventor has found that since there are typically few electrical components that are required to be mounted on surface 1202 of PCB 1200, the already available conductive area of the PCB between each LED of LED lighting module 2222 can be used for cooling. By adding the vias 1266 over the conductive area between each LED of LED lighting module 2222, heat dissipated by each LED of LED lighting module 2222 can be dissipated through vias 1266 to surface 1202 and the surface area available for cooling can be increased by a large factor. Optionally, at least a portion of vias 1266 are through holes vias. Optionally, at least a portion of the vias are blind vias open on one of surfaces 1202 or 1201.

Reference is now made to FIGS. 13A and 13B showing simplified diagrams of a two piece PCB structure showing slits on one of the PCB structures for a perpendicular connection with the another PCB in accordance with some embodiments of the present invention. According to some embodiments of the present invention, PCB 1101 includes one or more legs 1150 that match slots 1259 on PCB 1200. According to some embodiments of the present invention one or more legs 1150 and matching slots are coated with conductive material to provide electrical connection between PCB 1101 and PCB 1200. According to some embodiments of the present invention, PCB 1101 is connected, e.g. mounted on PCB 1200 head on. In some exemplary embodiments, PCB 1101 and 1200 are rigidly connected by injecting conductive glue between legs 1150 and slots 1259 and/or by soldering. Optionally, solder is performed by an automated process. Optionally one or more LED lighting modules, e.g. LEDs 151, 152 and 153 of one LED lighting module and LEDs 156, 157, and 158 of another LED lighting module are mounted on PCB 1200 with vias 1266 positioned around each LED. Typically, the LEDs 151, 152, 153, 156, 157, 158 are mounted on surface 1202 of PCB 1200 facing away from PCB 1101.

According to some embodiments of the present invention, one or more slots 1259 includes a prong 1250 that is connected on one end to PCB 1200 and acts as a clasp for holding leg 1150 within the slot. Optionally, prong 1250 is structured like a cantilever beam providing a spring force when bent for fixedly securing PCB leg 1150 in slot 1259. Optionally, prong 1250 is cut out of PCB 1200. Optionally, prong 1250 is coated or plated with conductive material on at least one surface and enable auto assembly during the soldering of the diode (LED). Optionally, slot 1259 also serves a thermal via.

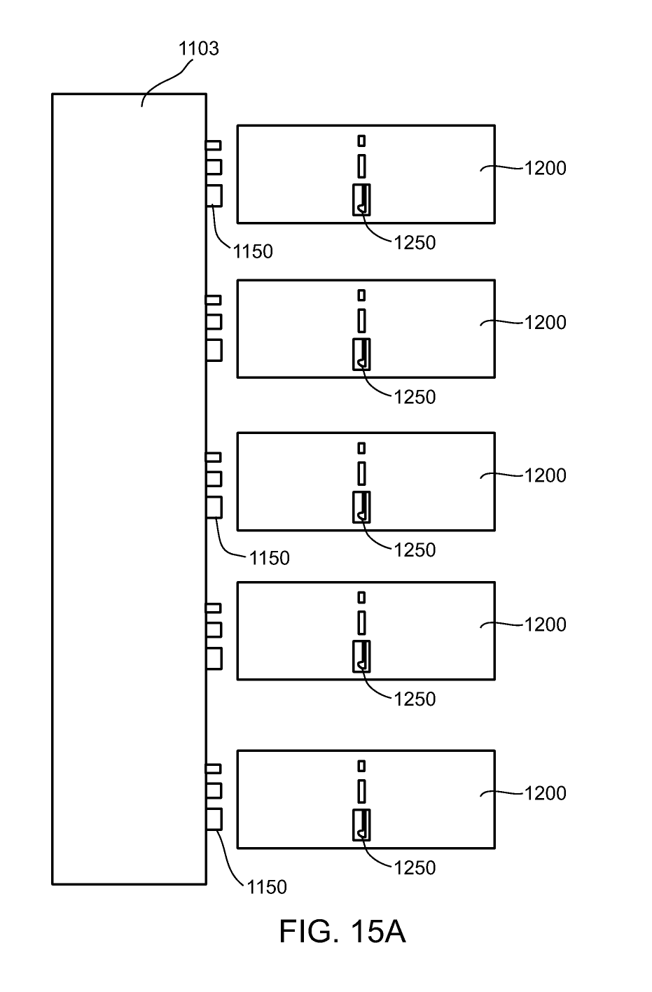

Reference is now made to FIGS. 14A and 14B showing simplified diagrams of a two piece PCB structure for an LED lighting unit with a pin head for attachment with a pin socket in accordance with some embodiments of the present invention. According to some embodiments of the present invention, lighting unit 1333 is similar to lighting unit 1100 but is adapted to be connected to a conventional pin socket and includes pin heads 1115 instead of attachment unit 1111. According to some embodiments of the present invention, pin heads 1115 are formed, e.g. cut out from PCB 1102 as are legs 1150. According to some embodiments of the present invention pin heads 1115 are plated with conductive material 11156 to provide for electrical connection between a pin socket, e.g. connected to an AC source and electrical components mounted on PCB 1102 and 1200.

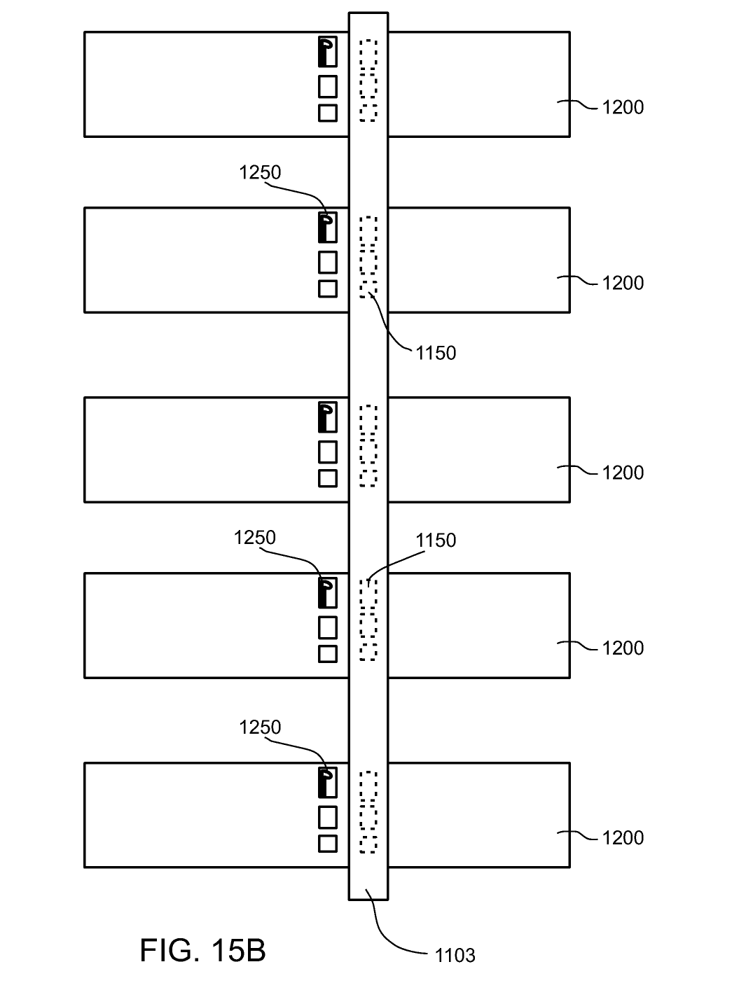

Reference is now made to FIGS. 15A and 15B showing simplified diagrams of a multi-piece PCB structure of an LED lighting unit in accordance with some embodiments of the present invention. According to some embodiments of the present invention, a single PCB 1103 electrically connected to a power source, e.g. an AC power source is connected to a plurality of PCB 1200 each of which include one or more LED lighting modules. According to some embodiments of the present invention, a single PCB 1103 includes a plurality of legs 1150 and/or other connecting elements for physically and electrically connecting with a plurality of PCBs 1200. Optionally, one or more PCB 1200 are connected with PCB 1103 using prongs 1250 as described in reference to FIGS. 13A and 13B. The present inventors have found that using multiple strips of PCBs 1200 instead of a single plate can reduce costs by reducing the overall dimension of PCB material required for the lighting unit.

It is noted that the circuits shown in FIGS. 1-6 are schematic nature and do not necessarily show all circuit elements of the fly-back converter. For example provisions for output voltage and current feedback are not shown. Optional multiple secondary windings for generating multiple isolated voltages are also not shown. In addition, a snubber circuit typically used to dissipate energy stored in leakage inductance of the primary winding while the switching elements are turned off is not shown. A person skilled in the art will appreciate that such elements have been excluded for ease of understanding and are not meant to limit the scope of the present invention.

It is also noted that although most of the embodiments of the present invention have been described in reference to LED lighting modules, the power converter can be similarly applied for powering other electronic devices such as personal computers, monitors, battery chargers for cellular telephones, laptop computers, netbook computers, and personal digital assistant, and for isolated power supplies.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

What is claimed is:

1. A method for controlling powering with a resonant fly-back power converter, the method comprising:
powering an output circuit including a load with a inductor of a resonant fly-back power converter including a primary winding electrically connected to an input circuit of the fly-back converter and secondary winding electrically connected to the output circuit of the fly-back converter; and
controlling charging and discharging of the primary winding with a first and second switching element, both first and second switching elements are operative to connect primary winding to an input voltage source over a defined on-time, wherein the pulsing of the first and second switching elements are synchronized and the on-time of the second switching element is extended with respect to the on-time of the first switching element.

2. The method according to claim 1, wherein the on-time of the first switching element defines a charge level of the primary winding.

3. The method according to claim 1 or claim 2, wherein the on-time of the second switching element defines a delay in an onset of a resonance period of the input circuit.

4. The method according to claim 3, wherein the extended on-time is defined to synchronize the pulsing with a first valley of resonance voltage of the input circuit.

5. The method according to claim 3 or claim 4, wherein the extended on-time is defined to synchronize pulsing with demagnetizing of the inductor.

6. The method according to any of claims 1-5, comprising directing current flow through a forward biased diode connected to the second switching element and the primary winding in response to release of the first switching element at the end of its on-time.

7. The method according to any of claims 1-6, comprising clamping current on the primary winding over the extended on-time of the second switching element.

8. The method according to any of claims 1-7, comprising discharging current on the primary winding to the output circuit after release of the second switching element.

9. The method according to any of claims 1-8, wherein the input voltage source is a DC source.

10. The method according to any of claims 1-9, wherein the converter operates at a constant switching frequency and wherein the on-time of the first switching element controls voltage output of the converter.

11. The method according to any of claims 1-9, wherein the converter operates at a variable switching frequency and wherein on-time of the first switching element is constant over each commutation cycle.

12. The method according to any of claims 1-11, wherein the load includes at least one LED lighting module.

13. A resonant fly-back power converter comprising:
an input DC voltage source;
an input circuit including:
first and second switching elements; and
a primary winding connected to the input voltage source via the first and second switching elements, each connected between a terminal of the primary winding and a terminal of the input voltage source, the winding being operative to supply power to an output circuit of the resonant fly-back power converter,
wherein the first switching element is pulsed at a defined switching frequency and has an on-time operative to provide a defined charge level on the primary winding;
wherein the second switching element is pulsed at the same switching frequency and in synchronization with the first switching element; and
wherein an on-time of the second switching element is extended with respect to the on-time of the first switching element.

14. The converter according to claim 13, comprising at least one controller operative to control duration of on-times for each of the first and second switching elements.

15. The converter according to claim 13 or claim 14, wherein the converter enters a resonant period at an end of a commutation cycle of the pulsing and wherein the extended on-time is operative to delay the onset of the resonance period of the input circuit.

16. The converter according to claim 15, wherein the extended on-time is defined to synchronize the pulsing with a first valley of resonance of the resonance period.

17. The converter according to any of claims 13-16, wherein release of any one of the first and second switching element is operative to disconnect the input voltage source from the primary winding.

18. The converter according to claim 17, wherein release of the first switching element while maintaining the second switching element closed is operative to direct current flow through a forward biased diode connected to the second switching element and the primary winding.

19. The converter according to claim 18, wherein the forward biased diode is operative to clamp current on the primary winding.

20. The converter according to any of claims 13-19, wherein termination of the extended on-time of the second switching element prompts discharge of current on the primary winding to the output circuit.

21. The converter according to any of claims 13-20, comprising a resonance capacitor parallel to the second switching element, wherein the resonance capacitor is charged at a termination of the extended on-time and just prior to discharge of current on the primary winding to the output circuit.

22. The converter according to any of claims 13-21, wherein the input voltage source is a DC source.

23. The converter according to any of claims 13-22, wherein the converter operates at a constant switching frequency and wherein the on-time of the first switching element controls voltage output of the converter.

24. The converter according to any of claims 13-22, wherein the converter operates at a variable switching frequency, wherein on-time of the first switching element is constant over each commutation cycle and wherein the switching frequency controls voltage output of the converter.

25. The converter according to any of claims 13-24, wherein the load of the output circuit includes one or more LED lighting modules.

26. An LED lighting unit comprising:
a first printed circuit board formed with a pre-defined shape for attachment to a socket;
at least one second printed circuit board including at least one LED lighting module; and
an attachment mechanism for physically and electrically connecting the first and second printed circuit board.

27. The LED lighting unit according to claim 26, wherein the pre-defined shape is adapted to be screwed into a screw socket.

28. The LED lighting unit according to claim 26, wherein the pre-defined shape is a pin head adapted to be clasped by a pin socket.

29. The LED lighting unit according to any of claims 26-28, wherein the attachment mechanism includes one or more legs shaped from the first printed circuit board and matching slots cut out from the second printed circuit board.

30. The LED lighting unit according to claim 29, wherein at least one slot includes bendable protrusion that bends in response to reception of a leg formed from the first printed circuit board.

31. The LED lighting unit according to claim 29 or claim 30, wherein at least a portion of the one or more legs and matching slots are coated with conductive material.

32. The LED lighting unit according to any of claims 26-31, wherein at least a portion of the pre-defined shape is plated with conductive material.

33. The LED lighting unit according to any of claims 26-32, wherein first and second printed circuit boards are connected substantially perpendicular to each other.

34. The LED lighting unit according to any of claims 26-33, wherein at least one of the first and second printed circuit board is plated with a material that can be used as a heat sink.

35. The LED lighting unit according to claim 34, wherein the material is cooper or aluminum.

36. The LED lighting unit according to any of claims 26-33, wherein the at least one second printed circuit board includes a plurality of vias operative to dissipate heat from the at least one lighting module.

37. The LED lighting unit according to any of claims 26-35, wherein the lighting unit is adapted for auto-assembly.
